(19) United States
(12) Patent Application Publication
(10) Pub. No.: US 2015/0225273 A1
(43) Pub. Date: Aug. 13, 2015

(54) SLUDGE CONDITIONING APPARATUS

(71) Applicant: CDE Global Limited, Cookstown County Tyrone (GB)

(72) Inventors: Kevin Vallelly, Maghera (GB); Anthony Convery, Moneymore (GB)

(21) Appl. No.: 14/619,867

(22) Filed: Feb. 11, 2015

(30) Foreign Application Priority Data
Feb. 12, 2014 (GB) 1402429.3

(51) Int. Cl. C02F 11/12

(52) U.S. Cl. CPC C02F 11/121

(57) ABSTRACT

A sludge conditioning apparatus includes at least one hopper for receiving waste water having solid impurities entrained therein, wherein the solid impurities settle out of suspension to be collected in a lower region of the hopper as sludge. The hopper includes a sludge outlet at a lower end thereof communicating with a pump for removing sludge therefrom. A sensing device is provided for determining the amount of sludge collected in the hopper, and the rate at which the sludge is removed by the pump is controlled by a control device, the control device controlling the operation of the pump to control the rate of removal of the sludge as a function of the output of the sensing device.

### CROSS REFERENCE TO RELATED APPLICATIONS

The present application claims the benefit of United Kingdom Pat. Application No. 1402429.3, filed Feb. 12, 2014, which is incorporated herein by reference in its entirety.

### FIELD OF THE INVENTION

This invention relates to a sludge conditioning apparatus of a waste water recycling system.

### BACKGROUND OF THE INVENTION

Waste water streams containing entrained solid impurities and contaminants in suspension are produced from numerous quarrying, mining, chemical or industrial processes. It is often desirable to reuse such water, particularly in regions prone to water shortages.

Before the waste water can be re-used, the impurities and contaminants must be removed from the water. This is typically done by passing the water into a settling tank wherein the fines are able to settle out under the action of gravity, typically after adding a flocculating agent to which the fines bind to bring them out of suspension.

The collected concentrated solids are removed from the lower region of the settling tank for subsequent dewatering and disposal. The cleaned or clarified water is removed from an upper region of the settling tank to be re-used, typically after passing over a weir in the upper region of the tank.

Once removed from the lower region of the settling tank, the sludge may be pumped or conveyed to a filter press or centrifuge for final dewatering or to ponds for storage/disposal. Typically the sludge is pumped from the bottom of the settling tank via a suitable pump. It is desirable for the sludge to be removed from the tank at a rate substantially equal to the rate of collection of the sludge in the bottom of the settling tank such that the sludge has a consistent density to ensure efficient and reliable operation of the pump and to suit the requirements of subsequent processes.

The rate of removal of the sludge may be adjusted as a function of the torque required to stir the sludge within the bottom of the settling tank via rotary rake systems, used to displace the sludge towards the centre of the typically conical settling tank, the torque being indicative of the slurry density. However, in known systems, the control of the density of the sludge has been unreliable and problematic, leading to inconsistent sludge properties downstream of the settling tank, reducing the efficiency of the next process.

### SUMMARY OF THE INVENTION

According to the present invention there is provided a sludge conditioning apparatus comprising at least one hopper for receiving waste water having solid impurities entrained therein, wherein the solid impurities settle out of suspension to be collected in a lower region of the hopper as sludge, the hopper having a sludge outlet at a lower end thereof communicating with a pump for removing sludge therefrom, a sensing device being provided for determining the amount of sludge collected in the hopper, the rate at which the sludge is removed by the pump being controlled by a control device, the control device controlling the operation of the pump to control the rate of removal of the sludge as a function of the output of the sensing device.

Optionally, the sensing device determines the weight of sludge collected in the hopper.

For example, the hopper may comprise an upper section and a lower section supported by the upper section, the sensing device comprising one or more load cells acting between the upper and lower sections of the hopper for determining the load applied to the upper section by the lower section.

The lower section of the hopper may be suspended from the upper section thereof. The upper and lower sections of the hopper may be linked by a flexible linking section. Optionally, the flexible linking section is formed from a resilient or elastic material.

The pump may be mounted beneath the hopper.

Optionally, the sludge outlet of the hopper communicates with the pump via a flexible or telescopic conduit permitting vertical displacement of the lower region of the hopper with respect to the pump.

At least the lower region of the hopper may comprise a conical body.

The control device may be programmed to adjust the operation of the pump to maintain the amount of sludge collected in the hopper between predetermined limits.

In one embodiment the sludge conditioning apparatus comprises a plurality of the hoppers arranged in series within an elongate housing, each hopper having a sludge outlet at a lower end thereof communicating with a separate pump for removing sludge therefrom, the pump being controlled by a control device in response to the output of a sensing device for determining the amount of sludge collected in the lower region of the respective hopper, wherein the control device controls the operation of the pump to control the rate of removal of the sludge from the respective hopper as a function of the output of the sensing device.

Each hopper may be located in a lower section of the elongate housing, each hopper extending from a settling tank located in an upper section of the elongate housing such that the hoppers define a lower region of the settling tank. A waste water inlet may be provided at a first end of the elongate housing delivering waste water in the settling tank, a clean water outlet being provided at a second end of the elongate housing, opposite the first end, for removing clean water from an upper region of the settling tank. The clean water outlet may be separated from the remainder of the settling tank via a weir over which clean water may flow to pass into the clean water outlet.

Optionally, the upper and lower sections of the elongate housing are separable from one another. The hoppers may be adapted to be raised up into the upper section of the elongate housing for transportation.

The dimensions of the upper and lower sections of the elongate housing may correspond to those of a standard shipping container.

A sludge conditioning apparatus in accordance with an embodiment of the present invention will now be described, by way of example only, with reference to the accompanying drawings.

### BRIEF DESCRIPTION OF THE DRAWINGS

FIG. 1 is a perspective view of a sludge conditioning apparatus in accordance with an embodiment of the present invention;

FIGS. 2 and 3 are detailed perspective views of the settling tank of the apparatus of FIG. 1;

FIG. 4 is a side view of the sludge conditioning apparatus of FIG. 1;

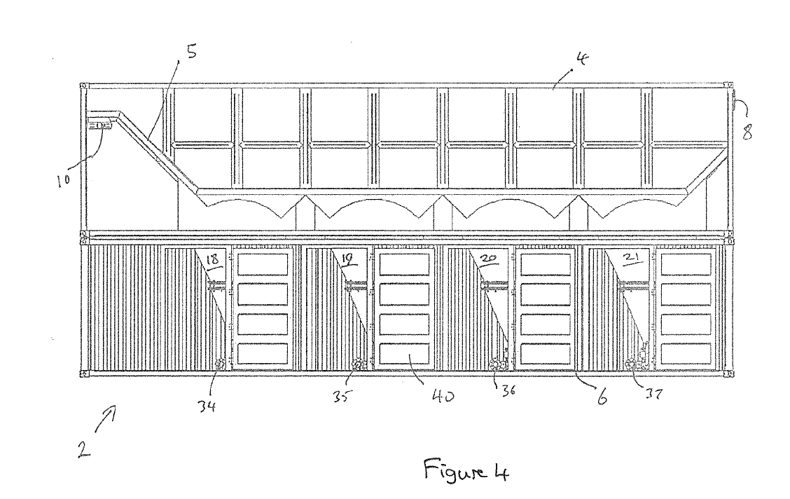

FIG. 5 is a plan view of the sludge conditioning apparatus of FIG. 1;

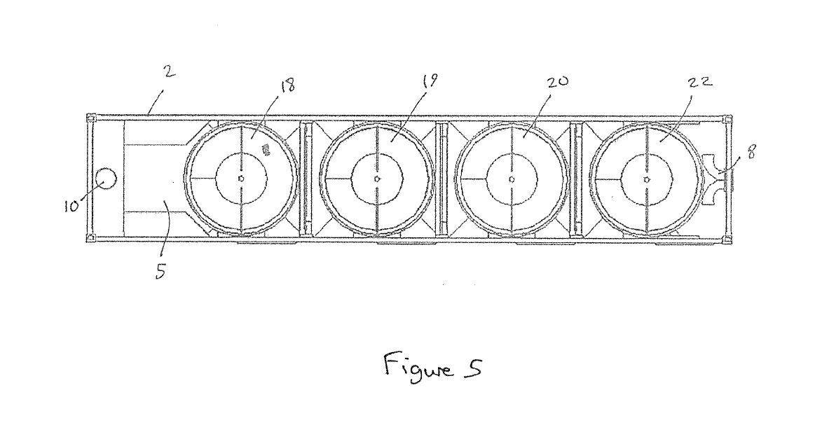

FIG. 6 is a longitudinal sectional view of the sludge conditioning apparatus of FIG. 1; and

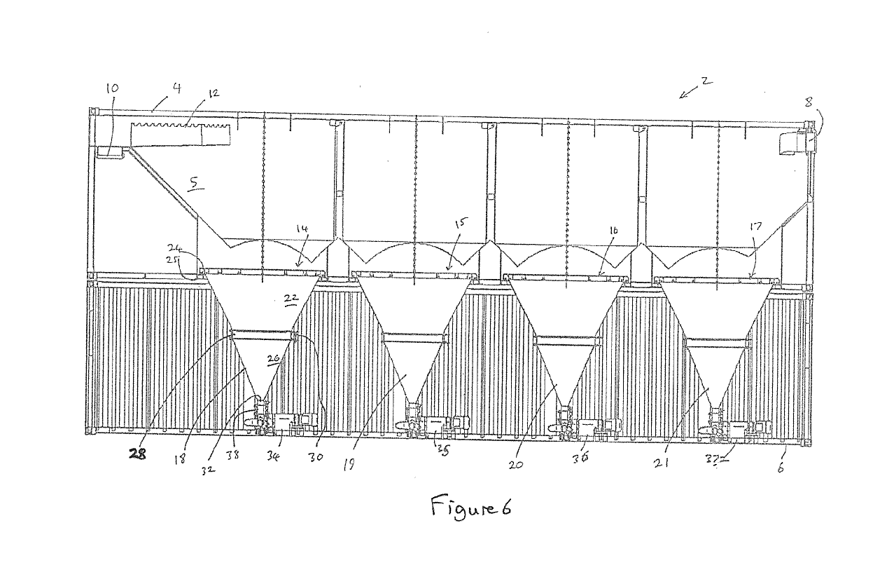

FIG. 7 is a longitudinal sectional view of the sludge conditioning apparatus of FIG. 1 with the hoppers in a raised position.

### DESCRIPTION OF THE PREFERRED EMBODIMENTS

A sludge conditioning apparatus in accordance with an embodiment of the present invention, as is illustrated in the drawings, comprising an elongate housing 2 formed from separable upper and lower sections 4,6 stacked upon one another. For example, each of the upper and lower sections 4,6 may be a right-angled parallelepiped having the dimensions of a standard shipping container to facilitate transportation of each section.

The upper section 4 of the housing 2 contains an open topped settling tank 5 having a waste water inlet 8 at a first end and a clean water outlet 10 at a second end, opposite the first end. The clean water outlet 10 is separated from the remainder of the settling tank 5 via a weir 12 located in an upper region of the settling tank 5, whereby only water adjacent the uppermost region of the settling tank 5 can pass into the clean water outlet 10.

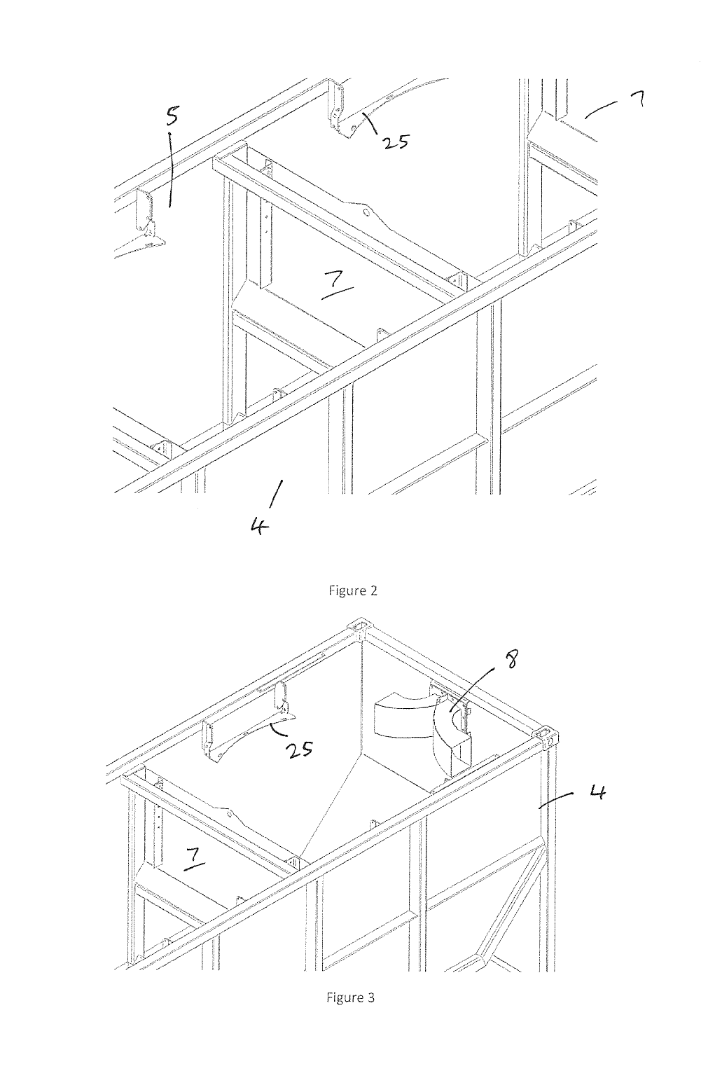

The settling tank 5 is divided into four sections separated by baffle plates 7 extending between the sides of the upper section 4 adjacent an upper region of the settling tank 5, such that waste water passing between the sections of the settling tank 5 must pass beneath the baffle plates, preventing waste water from passing directly from the waste water inlet 8 to the clean water outlet 10. The baffle plates 7 are best shown in FIGS. 2 and 3. The height of each baffle plate 7 may be adjusted, as desired.

A circular opening 14,15,16,17 are provided in the base of each section of the settling tank 5. A respective conical sludge collection hopper 18,19,20,21 is located within each of the circular openings 14,15,16,17 to depend therefrom to extend into the lower section 6 of the elongate housing 2.

Each sludge collection hopper 18,19,20,21 has an upper hopper section 22, having an upper peripheral flange 24 mounted on a locating flange 25 of the respective circular opening 14,15,16,17 in the base of the settling tank 5, and a lower hopper section 26 suspended from the upper hopper section 22 via a flexible connecting section 28. The flexible connecting section 28 is formed from an elastic or resilient material, such as rubber.

One or more load cells 30 are connected between the upper and lower hopper sections 22,26 of each hopper 18,19,20,21 for determining the load applied to the upper hopper section 22 by the lower hopper section 26 suspended therefrom.

A sludge outlet 32 is provided at the base of each hopper 18,19,20,21, each sludge outlet 32 being coupled to a respective pump 34,35,36,37 via a flexible or telescopic coupling pipe 38 for removing sludge from the hoppers and passing the sludge to a subsequent process, such as a dewatering centrifuge or filter press.

The load cells 30 are connected to a pump controller, whereby the operation of the pumps 34,35,36,37 can be controlled in response to the load measured by the load cells 30, as will be described in more detail below.

In use, waste water passes into the settling tank 5 via the waste water inlet 8. The waste water will be typically treated with a flocculant before passing into the settling tank 5. The fines bind to the flocculant, bringing them out of suspension, as is known in the art. The fines then settle out under the action of gravity and collect in the lower region of each hopper as sludge.

As the sludge builds up within the lower region of each hopper, the load applied to the respective upper hopper section 22 via the lower hopper section 26 increases and this increase in load is measured by the load cells 30. Thus the load cells 30 can be used to provide an accurate measure of the amount of sludge collected 20 within each hopper.

It is desirable to maintain the sludge level in each hopper substantially constant so that the sludge density at the outlet of each hopper remains constant to ensure efficient operation of the pump and to provide optimum sludge conditions for a subsequent process. To achieve this, the load measured by the load cells 30 of each hopper 18,19,20,21 can be used to control the operation of the associated pump 34,35,36,37 so that the rate of removal of the sludge by the pump is substantially equal to the rate of build up of sludge within the hopper, maintaining the level of sludge within each hopper within predetermined limits.

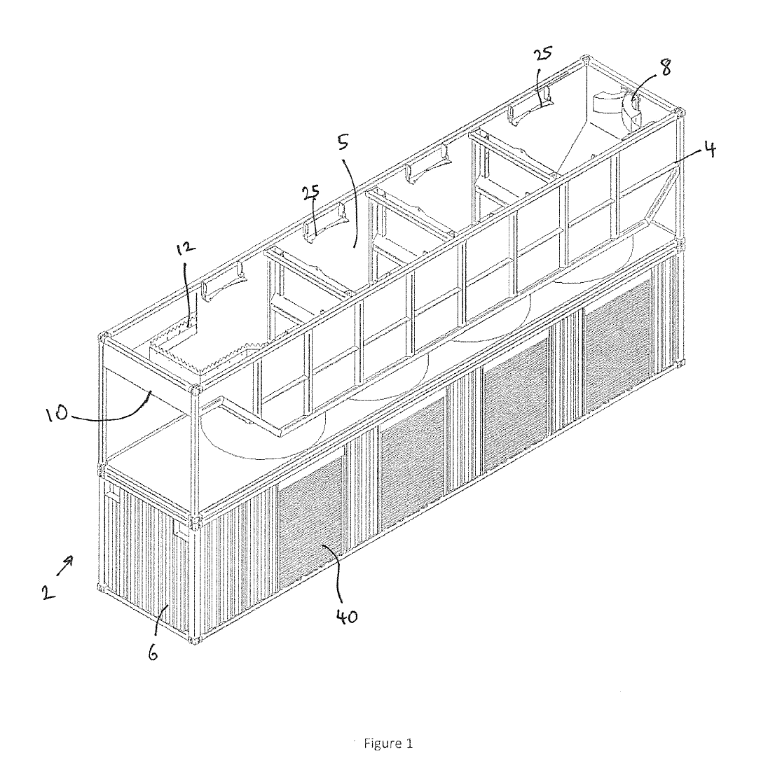

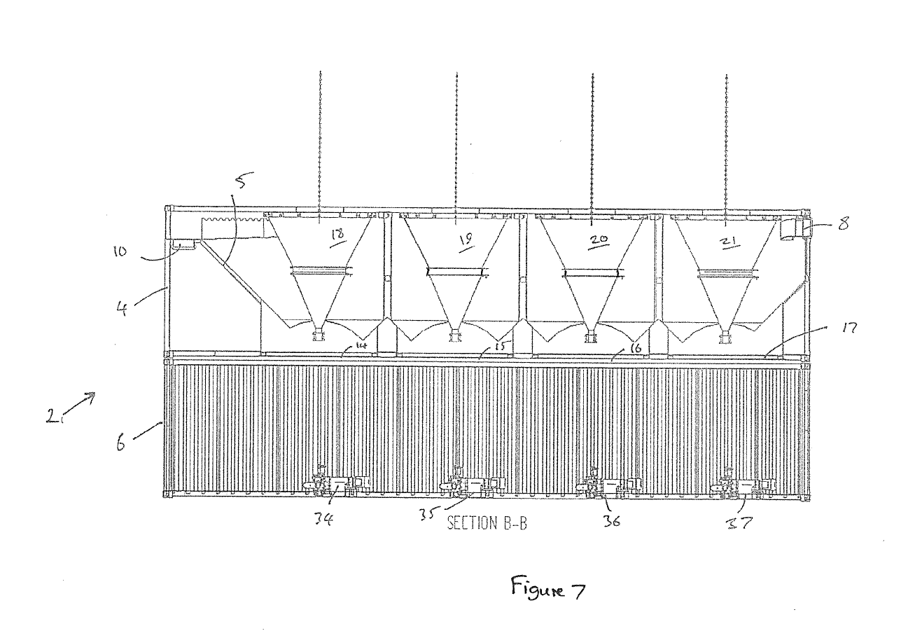

As illustrated in FIG. 7, when it is desired to separate the upper and lower sections 4, 6 of the elongate housing 2 of the apparatus for transportation, each hopper 18,19,20,21 can be disconnected from its respective pump 34,35,36,37, the hopper flanges 24 being releases from the respective openings 14,15,16,17 of the settling tank 5, and the hoppers 18,19,20,21 can be raised up into the upper section 4 of the elongate housing 2. The upper section 4 of the housing 2 may incorporate lifting device for raising the hoppers and connection flanges 25 (FIGS. 1 to 3) for securing the hoppers 18,19,20,21 within the upper section 4.

The lower section 6 of the elongate housing 2 may be provided with access doors 40 to permit access to the pumps and pump controller and to the hoppers to facilitate maintenance of the pumps and hoppers and to enable the hoppers to be disconnected and reconnected to the pumps and to the openings in the base of the upper section.

The invention is not limited to the embodiment(s) described herein but can be amended or modified without departing from the scope of the present invention. Changes and modifications in the specifically described embodiments can be carried out without departing from the principles of the present invention, which is intended to be limited only by the scope of the appended claims, as interpreted according the principles of patent law, including the doctrine of equivalents.

1. A sludge conditioning apparatus comprising:
at least one hopper for receiving waste water having solid impurities entrained therein, wherein the solid impurities settle out of suspension to be collected in a lower region of the hopper as sludge, the hopper having an upper section and a lower section supported by the upper section, with a sludge outlet at the lower section:
a pump in communication with the sludge outlet and operable to remove sludge therefrom;
a sensing device for determining the weight of sludge collected in the hopper, the sensing device including one or more load cells acting between the upper and lower sections of the hopper for generating an output indicative of the load applied to the upper section by the lower section; and
a control device operable to control the operation of the pump to control the rate of removal of the sludge as a function of the output of the sensing device.

2-3. (canceled)

4. A sludge conditioning apparatus as claimed in claim 1, wherein the lower section of the hopper is suspended from the upper section thereof.

5. A sludge conditioning apparatus as claimed in claim 4, wherein the upper and lower sections of the hopper are linked by a flexible linking section.

6. A sludge conditioning apparatus as claimed in claim 5, wherein the flexible linking section is formed from a resilient or elastic material.

7. A sludge conditioning apparatus as claimed in claim 1, wherein the pump is mounted beneath the hopper.

8. A sludge conditioning apparatus as claimed in claim 7, wherein the sludge outlet of the hopper communicates with the pump via a flexible or telescopic conduit permitting vertical displacement of the lower section of the hopper with respect to the pump.

9. A sludge conditioning apparatus as claimed in claim 1, wherein at least the lower section of the hopper comprises a conical body.

10. A sludge conditioning apparatus as claimed in claim 1, wherein the control device is programmed to adjust the operation of the pump to maintain the amount of sludge collected in the hopper between predetermined limits.

11. A sludge conditioning apparatus as claimed in claim 1 comprising a plurality of the hoppers arranged in series within an elongate housing, each hopper having a sludge outlet at a lower end thereof communicating with a separate pump for removing sludge therefrom, the pump being controlled by a control device in response to the output of a respective sensing device for determining the amount of sludge collected in the lower section of the respective hopper, wherein the control device controls the operation of the pump to control the rate of removal of the sludge from the respective hopper as a function of the output of the sensing device.

12. A sludge conditioning apparatus as claimed in claim 11, wherein each hopper is located in a lower section of the elongate housing, each hopper extending from a settling tank located in an upper section of the elongate housing such that the hoppers define a lower region of the settling tank.

13. A sludge conditioning apparatus as claimed in claim 12, wherein a waste water inlet is provided at a first end of the elongate housing delivering waste water in the settling tank, a clean water outlet being provided at a second end of the elongate housing, opposite the first end, for removing clean water from an upper region of the settling tank.

14. A sludge conditioning apparatus as claimed in claim 13, wherein the clean water outlet is separated from the remainder of the settling tank via a weir over which clean water may flow to pass into the clean water outlet.

15. A sludge conditioning apparatus as claimed in claim 12, wherein the upper and lower sections of the elongate housing are separable from one another.

16. A sludge conditioning apparatus as claimed in claim 15, wherein the hoppers are adapted to be raised up into the upper section of the elongate housing for transportation.

17. A sludge conditioning apparatus as claimed in claim 15, wherein the dimensions of the upper and lower sections of the elongate housing correspond to those of a standard shipping container.
